(19) United States
(12) Patent Application Publication
(10) Pub. No.: US 2020/0241297 A1
(43) Pub. Date: Jul. 30, 2020

(54) DRIVE DEVICE USED IN HEAD-UP DISPLAY DEVICE AND HEAD-UP DISPLAY DEVICE

(71) Applicant: NIDEC SANKYO CORPORATION, Nagano (JP)

(72) Inventors: Hiroyuki HATASAKO, NAGANO (JP); Takanori OHKAWA, Nagano (JP); Takafumi KASUGA, NAGANO (JP); Takahisa UEKI, NAGANO (JP); Ken NOGUCHI, Niigata (JP); Masahiro WATANABE, Niigata (JP); Daiki FUNAMI, Niigata (JP)

(73) Assignee: NIDEC SANKYO CORPORATION, NAGANO (JP)

(21) Appl. No.: 16/742,929

(22) Filed: Jan. 15, 2020

(30) Foreign Application Priority Data
Jan. 25, 2019 (JP) 2019-010728

(51) Int. Cl. G02B 27/01; B60K 35/00; H02P 8/22

(52) U.S. Cl. CPC G02B 27/0149; B60K 35/00; H02P 8/22; G02B 2027/0163; B60K 2370/691; B60K 2370/334; B60K 2370/1529; B60K 2370/688; G02B 2027/0154

(57) ABSTRACT

A drive device used in a head-up display device, the drive device being accommodated in a housing of the head-up display device and being fixed to the housing. The drive device includes a motor having a rotation shaft and a motor case having an end face through which the rotation shaft is protruded, a vibration suppressing member, and a frame provided with a first plate part having a through hole and a second plate part extended from the first plate part. The motor is fixed to the first plate part in a state that the rotation shaft is penetrated through the through hole and the end face is contacted with the first plate part, the vibration suppressing member is fixed to the first plate part or the motor case, and the second plate part is provided with a frame side fixed part which is to be fixed to the housing.

### CROSS REFERENCE TO RELATED APPLICATION

The present invention claims priority under 35 U.S.C. § 119 to Japanese Application No. 2019-010728 filed Jan. 25, 2019, the entire content of which is incorporated herein by reference.

### TECHNICAL FIELD

The present invention relates to a drive device used in a head-up display device structured to project a display light to a windshield of a vehicle or the like, and relates to the head-up display device.

### BACKGROUND

A head-up display device for a vehicle is described in Japanese Patent Laid-Open No. 2017-154712 (Patent Literature 1). The head-up display device described in the literature includes a display means structured to emit a display light, a reflecting mirror which reflects the emitted display light toward a windshield, and a drive mechanism structured to turn the reflecting mirror around a predetermined turning axis. The display means, the reflecting mirror and the drive mechanism are accommodated in a housing and are assembled into a front panel of a vehicle. The drive mechanism includes a motor as a drive source. When the drive mechanism is operated by driving of the motor, the reflecting mirror is turned around the turning axis. As a result, a projection position of the display light projected on a windshield is adjusted according to a height of eyes of an occupant.

The motor of the drive mechanism is fixed to the housing through a plate-shaped frame or the like. In this structure, when the motor is driven, noise may be generated due to a resonance of the stator caused by rotation of the rotor.

In view of the problem described above, the present invention provides a drive device used in a head-up display device capable of restraining occurrence of noise and a head-up display device.

### SUMMARY

To solve the above-mentioned problem, the present invention provides a drive device used in a head-up display device, the drive device being accommodated in a housing of the head-up display device and being fixed to the housing. The drive device includes a motor including a rotation shaft and a motor case having an end face through which the rotation shaft is protruded, a vibration suppressing member, and a frame provided with a first plate part having a through hole and a second plate part which is extended from the first plate part in a direction intersecting the first plate part, and the motor is fixed to the first plate part in a state that the rotation shaft is penetrated through the through hole and the end face is contacted with the first plate part. The vibration suppressing member is fixed to the first plate part or the motor case, and the second plate part is provided with a frame side fixed part which is to be fixed to the housing.

According to the present invention, the vibration suppressing member is fixed to the first plate part of the frame to which the end face of the motor case is fixed, or the vibration suppressing member is fixed to the motor case. As a result, a resonance frequency of the motor can be shifted and thus, occurrence of noise can be prevented or restrained.

Further, the present invention provides a drive device used in a head-up display device, the drive device being accommodated in a housing of the head-up display device and being fixed to the housing. The drive device includes a motor including a rotation shaft and a motor case having an end face through which the rotation shaft is protruded, a vibration suppressing member, and a frame provided with a first plate part having a through hole, a second plate part extended from the first plate part in a direction intersecting the first plate part, and a third plate part which faces the first plate part with a space interposed therebetween. The motor is fixed to the first plate part in a state that the rotation shaft is penetrated through the through hole and the end face is contacted with the first plate part, and a tip end of the rotation shaft penetrated through the through hole is rotatably supported by a support part provided in the third plate part. The vibration suppressing member is fixed to the first plate part, the third plate part or the motor case, and the second plate part is provided with a frame side fixed part which is to be fixed to the housing.

According to the present invention, the vibration suppressing member is fixed to the first plate part of the frame to which the motor case is fixed, or the vibration suppressing member is fixed to the motor case. Alternatively, the vibration suppressing member is fixed to the third plate part provided with a support part which rotatably supports the rotation shaft. As a result, a resonance frequency of the motor can be shifted and thus, occurrence of noise can be prevented or restrained.

In the present invention, it may be structured that the first plate part is provided with a protruded portion which is protruded to an outer side in a radial direction with respect to the motor case when viewed in an axial line direction along the rotation shaft, the vibration suppressing member is a weight made of metal, and the weight is fixed to the protruded portion. According to this structure, the weight is fixed to the first plate part which is integrated with the motor by fixing the motor case to the first plate part. Therefore, in comparison with a case that a weight is fixed to the third plate part separated from the motor case, a resonance frequency of the motor is easily shifted. Further, when a weight is fixed to the first plate part of the frame, a resonance frequency of the motor can be shifted without performing work for fixing the weight to the motor. In addition, when a weight is fixed to the protruded portion which is protruded to an outer side in the radial direction with respect to the motor case, a fixed position of the weight can be separated from the rotation shaft. Therefore, in comparison with a case that a weight is fixed to a position near the rotation shaft, a resonance frequency of the motor can be shifted with a light weight.

In the present invention, it may be structured that the protruded portion is provided with a fixing hole for fixing the weight, the weight is provided with a weight main body part which is contacted with one side face of the first plate part to cover the fixing hole, and a shaft part which is protruded from the weight main body part to penetrate through the fixing hole, and the shaft part is provided with a plastically deformed portion which is provided at an end on an opposite side to the weight main body part and is contacted with the other face of the first plate part to cover the fixing hole. According to this structure, even when a vehicle vibrates and the housing of the head-up display device is vibrated, the weight can be prevented or restrained from falling off from the frame.

In the present invention, it may be structured that the one side face of the first plate part with which the weight main body part is contacted is a face with which the end face of the motor case is contacted. According to this structure, the weight main body part can be prevented from being located on an outer side in a radial direction of an output side portion of the rotation shaft which is protruded from the motor case.

In the present invention, it may be structured that the protruded portion is protruded in a vertical direction with respect to the motor case. When the weight is disposed in a vertical direction with respect to the motor case, imbalance of moment occurred in the motor when the rotation shaft is rotated can be restrained. Therefore, vibration of the motor when the rotation shaft is rotated can be restrained.

In the present invention, it may be structured that the protruded portion comprises a first protruded portion and a second protruded portion which is protruded to an opposite direction to the first protruded portion with the through hole interposed therebetween, and the weight comprises a first weight fixed to the first protruded portion and a second weight fixed to the second protruded portion. According to this structure, the first weight and the second weight can be disposed on both sides of the rotation shaft. As a result, imbalance of moment occurred in the motor when the rotation shaft is rotated can be restrained. Therefore, vibration of the motor when the rotation shaft is rotated can be restrained.

In the present invention, it may be structured that the motor includes a magnet fixed to the rotation shaft and a coil surrounding the magnet from an outer peripheral side, the motor case includes a plate member having the end face and a case body in a ring shape which accommodates the magnet and the coil on an inner peripheral side, the plate member is provided with a case protruded portion which is protruded to an outer side in a radial direction with respect to the case body when viewed in an axial line direction along the rotation shaft, the vibration suppressing member is a weight made of metal, and the weight is fixed to the case protruded portion. Also in this structure, a resonance frequency of the motor can be shifted.

In the present invention, it is desirable that the motor is a stepping motor and is micro step-driven. According to this structure, the rotation shaft is smoothly rotated.

In the present invention, it may be structured that the drive device further includes a male screw part which is provided in an output side portion of the rotation shaft which is protruded from the motor case, a guide shaft which is extended between the first plate part and the third plate part so as to be parallel to the rotation shaft, and a movable member including a nut engaged with the male screw part and a guide hole through which the guide shaft is penetrated, and the movable member is disposed between the first plate part and the third plate part and, when the rotation shaft is rotated by driving of the motor, the movable member is moved along the rotation shaft. According to this structure, an outside member can be driven by connecting the movable member with the outside member. Further, the first plate part and the third plate part are connected with each other by the guide shaft and thus, rigidity of the frame is increased. Therefore, vibration of the frame when the rotation shaft is rotated can be restrained.

Next, a head-up display device in accordance with the present invention includes the above-mentioned drive device, a reflecting mirror which reflects a display light, a support mechanism which turnably supports the reflecting mirror around a predetermined turning center line, a link member which connects the reflecting mirror with the movable member, and a housing which accommodates the drive device, the support mechanism and the link member. The frame side fixed part is fixed to the housing and, when the movable member is moved by driving of the motor, the reflecting mirror is turned around the turning center line.

According to the present invention, occurrence of noise from the motor in the drive device can be restrained. Therefore, occurrence of noise from the head-up display device can be prevented or restrained.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic cross-sectional view showing a head-up display device.

FIG. 2 is a perspective view showing a drive device which is used in a head-up display device.

FIG. 3 is a perspective view showing a drive device which is viewed from a side of a motor case.

FIG. 4 is a side view showing a drive device.

FIG. 5 is a partial enlarged view showing a movable member and its surrounding portion.

FIG. 6 is an exploded perspective view showing a drive device.

FIG. 7 is an exploded perspective view showing a motor.

FIG. 8 is a perspective view showing a drive device in a first modified embodiment.

FIG. 9 is a perspective view showing a drive device in a second modified embodiment.

FIG. 10 is a perspective view showing a drive device in a third modified embodiment.

### DETAILED DESCRIPTION

### Effects of the Invention

According to the present invention, noise occurred in the drive device when the rotation shaft is rotated can be prevented or restrained. Therefore, noise occurred in the head-up display device when the drive device is driven can be prevented or restrained.

Other features and advantages of the invention will be apparent from the following detailed description, taken in conjunction with the accompanying drawings that illustrate, by way of example, various features of embodiments of the invention.

A head-up display device and a drive device in accordance with an embodiment of the present invention will be described below with reference to the accompanying drawings.

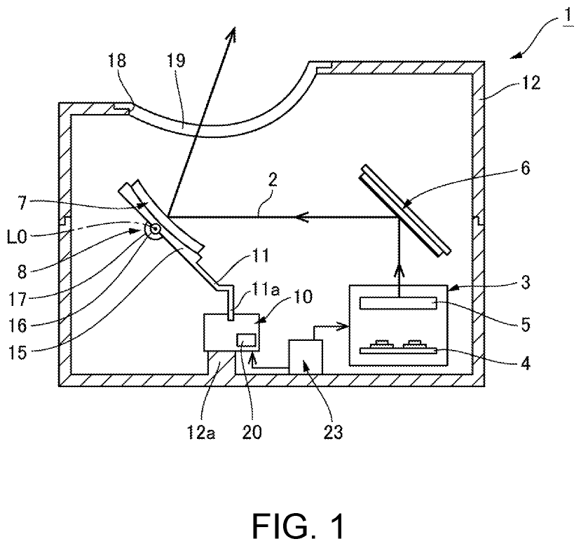

FIG. 1 is an explanatory view showing a head-up display device. A head-up display device 1 in this embodiment is installed in an inside of an instrument panel of a vehicle, and a display light is projected to a windshield of the vehicle. A projection image of the head-up display device 1 projected to the windshield through projection of a display light 2 indicates, for example, speed of the vehicle and an engine rotating speed.

As shown in FIG. 1, the head-up display device 1 includes a display light emitting device 3 structured to emit a display light 2. The display light emitting device 3 includes a light source 4 which emits a light source light, and a liquid crystal display element 5 which modulates the light source light based on an image signal corresponding to a projection image to emit a display light 2.

Further, the head-up display device 1 includes a fixed mirror 6 which reflects the display light 2 from the display light emitting device 3 and a reflecting mirror 7 which reflects the display light 2 reflected by the fixed mirror 6 to guide to the windshield. In addition, the head-up display device 1 includes a support mechanism 8 which turnably supports the reflecting mirror 7 around a predetermined turning center line “L0”, a drive device 10 structured to turn the reflecting mirror 7, and a link member 11 which connect the reflecting mirror 7 with the drive device 10. Further, the head-up display device 1 includes a housing 12 which accommodates the drive device 10, the support mechanism 8 and the link member 11.

The fixed mirror 6 is a plane mirror. The reflecting mirror 7 is a concave mirror. The support mechanism 8 includes a mirror holder 15 which holds the reflecting mirror 7. The mirror holder 15 includes a support shaft 16 perpendicular to an optical axis of the display light 2. The support shaft 16 is turnably supported by bearings 17 provided on inner side faces of the housing 12. An axial line of the support shaft 16 is the turning center line “L0” of the reflecting mirror 7. The drive device 10 includes a motor 20 as a drive source. The link member 11 is extended from the mirror holder 15 in a direction intersecting the support shaft 16. A tip end portion 11a of the link member 11 is connected with the drive device 10. The housing 12 is formed in a box shape and is provided with an opening part 18 through which the display light 2 is passed from the reflecting mirror 7 toward the windshield. The opening part 18 is covered by a light transmissive cover 19. The housing 12 is provided with a fixing part 12a for fixing the drive device 10.

When the drive device 10 is operated by driving of the motor 20, the link member 11 is driven to turn the reflecting mirror 7 around the axial line (turning center line “L0”) of the support shaft 16. As a result, a projection position of the display light 2 projected on the windshield is adjusted according to a height of eyes of an occupant.

### (Drive Device)

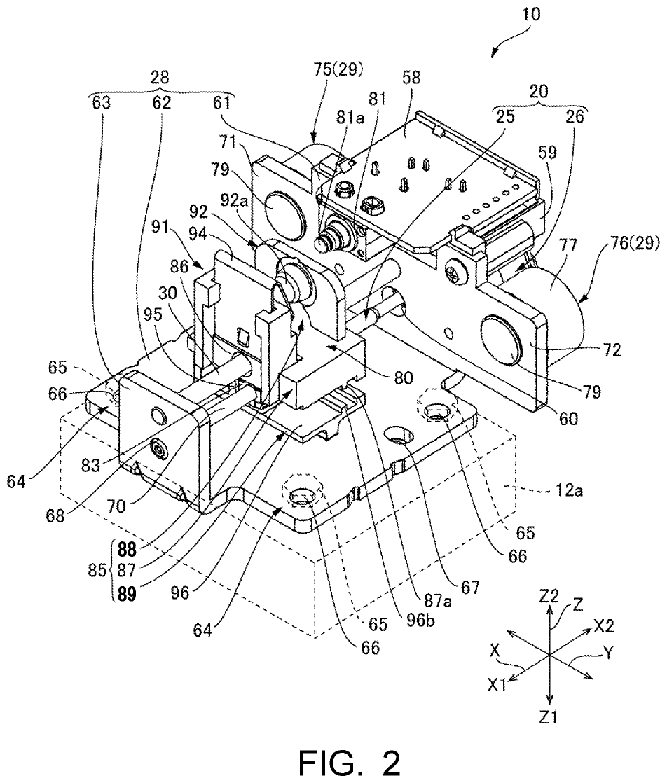

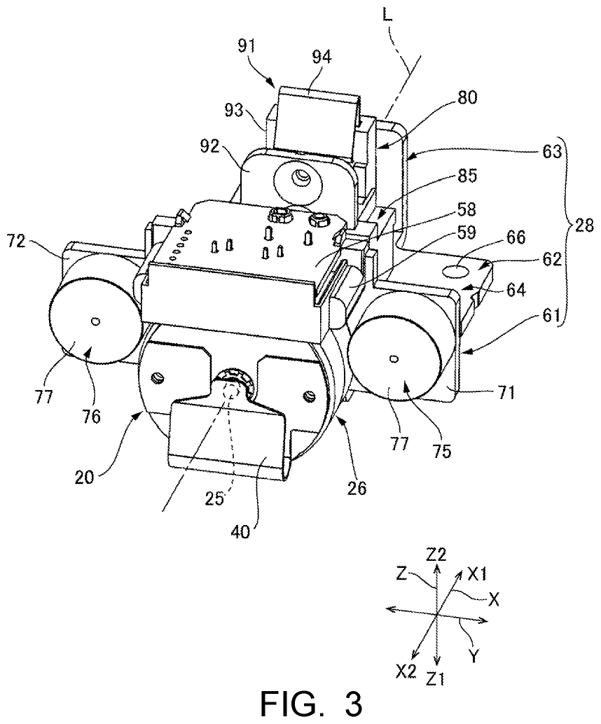

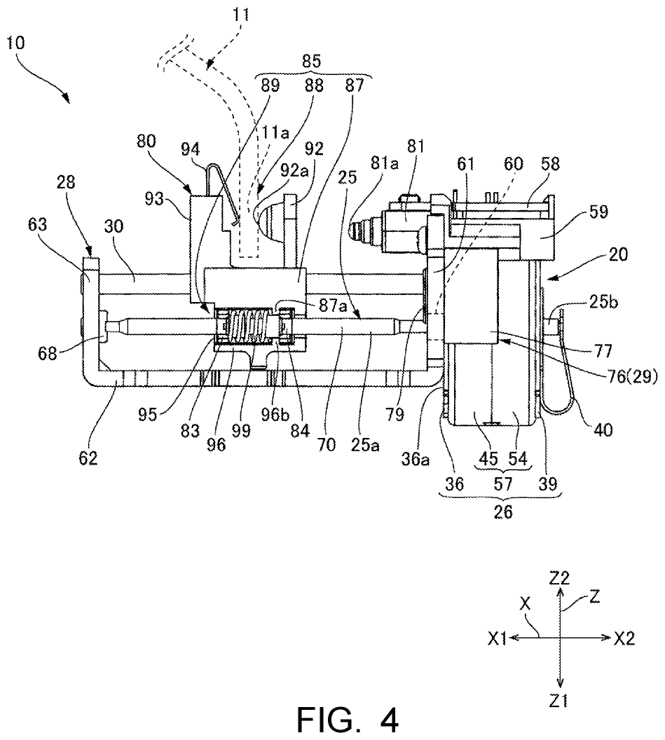

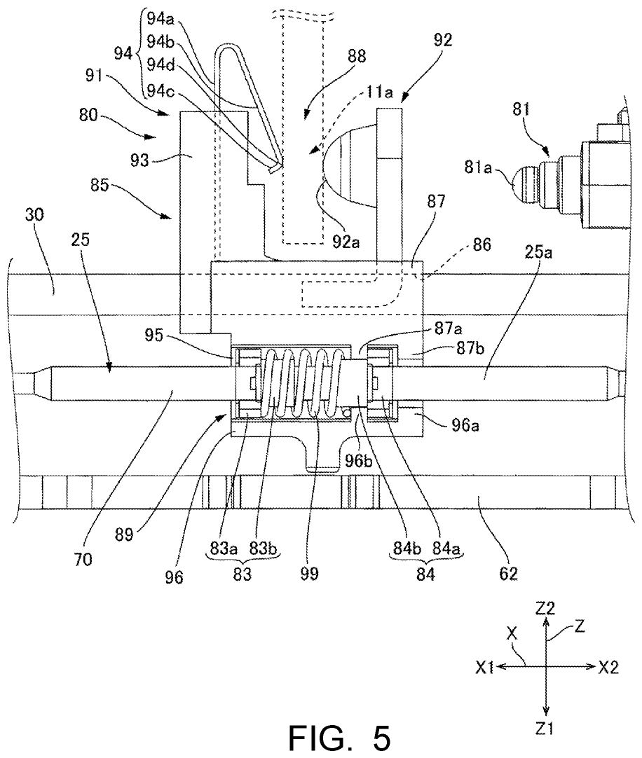

FIG. 2 is a perspective view showing the drive device 10 used in the head-up display device 1 which is viewed from a side where the frame is located. FIG. 3 is a perspective view showing the drive device 10 which is viewed from a side where a motor case is located. FIG. 4 is a side view showing the drive device 10 which is viewed in a direction perpendicular to a rotation shaft of the motor 20. FIG. 5 is a partial enlarged view showing a movable member and its surrounding portion.

As shown in FIGS. 2 through 4, the drive device 10 includes the motor 20 having a rotation shaft 25 and a motor case 26 from which the rotation shaft 25 is protruded, a frame 28 to which the motor 20 is fixed, and a vibration suppressing member 29 fixed to the frame 28. Further, the drive device 10 includes a guide shaft 30 extended in parallel to the rotation shaft 25, a movable member 80 movable along the rotation shaft 25, and a switch 81 supported by the frame 28. A posture of the drive device 10 shown in FIGS. 2 through 4 is a reference posture when the drive device 10 is fixed to the fixing part 12a of the housing 12 of the head-up display device 1. In the following descriptions, a direction along the axial line “L” of the rotation shaft 25 of the motor 20 in the reference posture is defined as an axial line direction “X”. In the axial line direction “X”, a side where the frame 28 is located is referred to as a first direction “X1” and a side where the motor case 26 is located is referred to as a second direction “X2”. Further, two directions perpendicular to the axial line direction “X” are defined as a width direction “Y” and an upper and lower direction “Z”. The upper and lower direction “Z” is the upper and lower direction “Z” in the reference posture. In this embodiment, the upper and lower direction “Z” is a vertical direction. The rotation shaft 25 is located on a lower side “Z1” with respect to the guide shaft 30.

### (Motor)

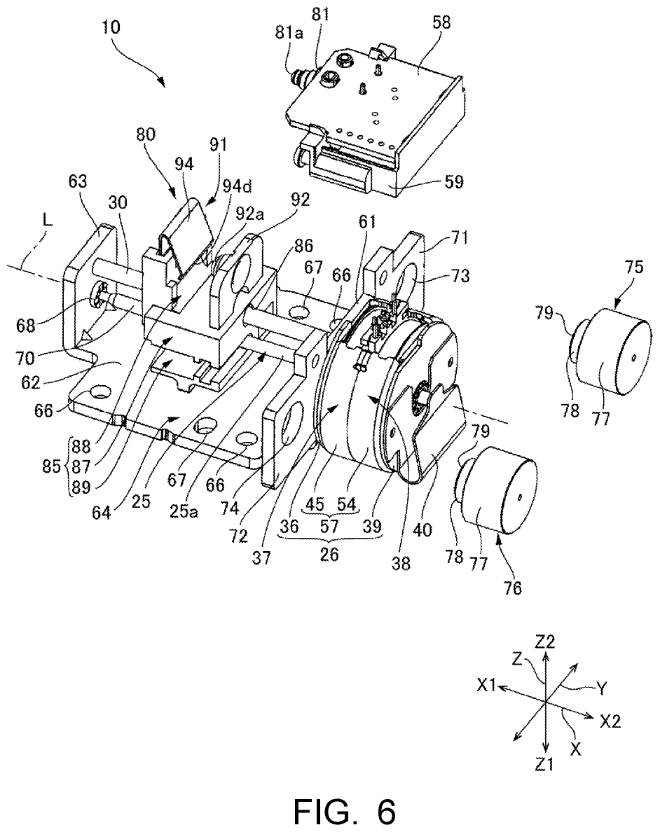

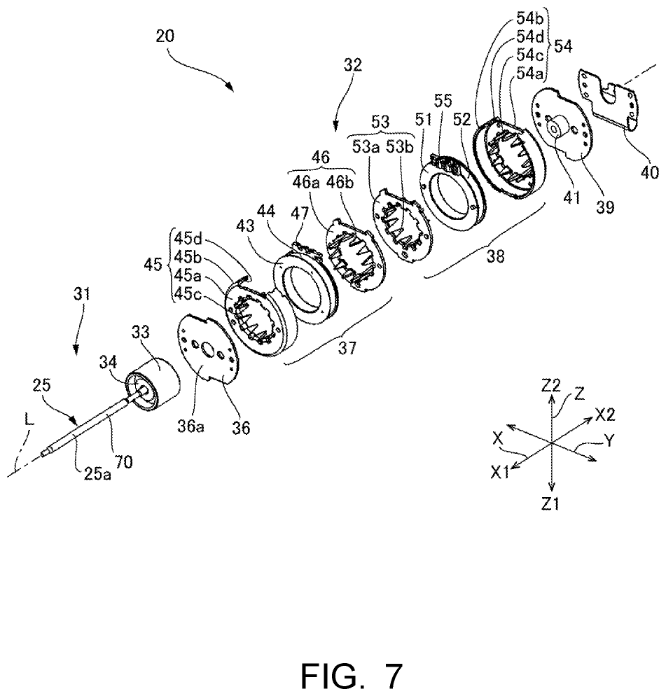

FIG. 6 is an exploded perspective view showing the drive device 10. FIG. 7 is an exploded perspective view showing the motor 20. As shown in FIG. 7, the motor 20 is a stepping motor having a rotor 31 and a stator 32. The rotor 31 includes the rotation shaft 25 and a magnet 33 in a circular ring shape which is fixed to an end portion in the second direction “X2” of the rotation shaft 25. The magnet 33 is fixed to the rotation shaft 25 through a magnet holder 34. The rotation shaft 25 and the magnet 33 are coaxially provided with each other. An “N”-pole and an “S”-pole are alternately disposed in a circumferential direction on an outer peripheral face of the magnet 33.

The stator 32 includes an output side end plate member (plate member) 36, an “A”-phase stator assembly 37, a “B”-phase stator assembly 38, an opposite-to-output side end plate member 39 and an urging member 40 along the axial line direction “X”. The output side end plate member 36 and the opposite-to-output side end plate member 39 are ring-shaped plates having a constant thickness. A bearing 41 is held in a center hole of the opposite-to-output side end plate member 39.

The “A”-phase stator assembly 37 includes a first bobbin 43, a first coil 44 wound around the first bobbin 43, a first outer stator core 45 disposed on the first direction “X1” side of the first bobbin 43, and a first inner stator core 46 disposed on the second direction “X2” side of the first bobbin 43. The first bobbin 43 is formed with a pair of flange parts at both ends of a cylindrical tube part around which a winding structuring the first coil 44 is wound, and one of the flange parts is integrally formed with a first terminal block 47. The first terminal block 47 holds first terminal pins not shown.

The first outer stator core 45 is provided with a circular ring-shaped end plate part 45a, a tube-shaped part 45b extended to the second direction “X2” from an outer periphery end of the circular ring-shaped end plate part 45a, and a plurality of pole teeth 45c which are stood up to the second direction “X2” from an inner circumferential edge of the circular ring-shaped end plate part 45a. Further, the tube-shaped part 45b is provided with a cut-out part 45d which is formed at a position corresponding to the first terminal block 47 of the first bobbin 43. The first inner stator core 46 is provided with a circular ring-shaped end plate part 46a and a plurality of pole teeth 46b which are stood up to the first direction “X1” from an inner circumferential edge of the circular ring-shaped end plate part 46a. The first inner stator core 46 closes an opening end of the tube-shaped part 45b by assembling the circular ring-shaped end plate part 46a to the first outer stator core 45. The first bobbin 43 and the first coil 44 are accommodated between the first outer stator core 45 and the first inner stator core 46. The first terminal block 47 and the first terminal pins are exposed outside through the cut-out part 45d of the first outer stator core 45.

The “B”-phase stator assembly 38 is arranged so that its posture is reversed to the “A”-phase stator assembly 37 in the axial line direction “X”. The “B”-phase stator assembly 38 includes a second bobbin 51, a second coil 52 wound around the second bobbin 51, a second inner stator core 53 disposed on the first direction “X1” side of the second bobbin 51, and a second outer stator core 54 disposed on the second direction “X2” side of the second bobbin 51. The second bobbin 51 is formed with a pair of flange parts at both ends of a cylindrical tube part around which a winding structuring the second coil 52 is wound, and one of the flange parts is integrally formed with a second terminal block 55. The second terminal block 55 holds second terminal pins not shown.

The second outer stator core 54 is provided with a circular ring-shaped end plate part 54a, a tube-shaped part 54b extended to the first direction “X1” from an outer periphery end of the circular ring-shaped end plate part 54a, and a plurality of pole teeth 54c which are stood up to the first direction “X1” from an inner circumferential edge of the circular ring-shaped end plate part 54a. The tube-shaped part 54b is provided with a cut-out part 54d which is formed at a position corresponding to the second terminal block 55 of the second bobbin 51. The second inner stator core 53 is provided with a circular ring-shaped end plate part 53a and a plurality of pole teeth 53b which are stood up to the second direction “X2” from an inner circumferential edge of the circular ring-shaped end plate part 53a. The second inner stator core 53 closes an opening end of the tube-shaped part 54b by assembling the circular ring-shaped end plate part 53a to the second outer stator core 54. The second bobbin 51 and the second coil 52 are accommodated between the second outer stator core 54 and the second inner stator core 53. The second terminal block 55 and the second terminal pins are exposed outside through the cut-out part 54d of the second outer stator core 54.

In the “A”-phase stator assembly 37 and the “B”-phase stator assembly 38, the circular ring-shaped end plate part 46a structuring an end face in the second direction “X2” of the “A”-phase stator assembly 37 and the circular ring-shaped end plate part 53a structuring an end face in the first direction “X1” of the “B”-phase stator assembly 38 are joined to each other. Further, the output side end plate member 36 is joined to the circular ring-shaped end plate part 45a structuring an end face in the first direction “X1” of the “A”-phase stator assembly 37, and the opposite-to-output side end plate member 39 is joined to the circular ring-shaped end plate part 54a structuring an end face in the second direction “X2” of the “B”-phase stator assembly 38. In this embodiment, as shown in FIG. 6, the output side end plate member 36, the first outer stator core 45, the second outer stator core 54 and the opposite-to-output side end plate member 39 also serve as the motor case 26 which accommodates the magnet 33, the first coil 44 and the second coil 52 on an inner peripheral side. The first outer stator core 45 and the second outer stator core 54 are a ring-shaped case body 57 which accommodates the magnet 33, the first coil 44 and the second coil 52 on an inner peripheral side.

An output side portion 25a of the rotation shaft 25 is protruded to the first direction “X1” through a center hole of the output side end plate member 36. Therefore, as shown in FIG. 4, the end face 36a on the first direction “X1” side of the output side end plate member 36 is the end face 36a of the motor case 26 through which the rotation shaft 25 is protruded. Further, an end part 25b on an opposite-to-output side of the rotation shaft 25 is supported by the bearing 41 which is held by the center hole of the opposite-to-output side end plate member 39. The bearing 41 supports the rotation shaft 25 rotatable around the axial line “L” and movable in the axial line direction “X”. In this embodiment, an urging member 40 is fixed to the opposite-to-output side end plate member 39 on the second direction “X2” side. The urging member 40 is a plate spring, which urges to the first direction “X1” an end on the second direction “X2” side of the rotation shaft 25 protruded through the motor case 26.

A circuit board 58 is connected with the first terminal pins of the “A”-phase stator assembly 37 and the second terminal pins of the “B”-phase stator assembly 38. The circuit board 58 is supported by the frame 28 through a circuit board holder 59. A switch 81 is connected with the circuit board 58. Further, the circuit board 58 is connected with wiring lines for power feeding to the first coil 44 and the second coil 52 and a signal line for taking out a signal from the switch 81 to the outside. Power feeding to the first coil 44 and the second coil 52, in other words, driving of the motor 20 is controlled by a control part 23 (see FIG. 1) which is mounted on the head-up display device 1. The motor 20 is micro step-driven by the control part 23.

### (Frame, Vibration Suppressing Member and Guide Shaft)

As shown in FIG. 2, the frame 28 is provided with a first plate part 61 having a through hole 60, a second plate part 62 extended from the first plate part 61 in a direction intersecting the first plate part 61, and a third plate part 63 which faces the first plate part 61 with a space interposed therebetween. The first plate part 61 is extended to the upper side “Z2”. The through hole 60 is provided at a center in the width direction “Y” of the first plate part 61. The second plate part 62 is extended from the first plate part 61 to the first direction “X1” which is perpendicular to the first plate part 61

The second plate part 62 is formed in a quadrangular shape when viewed in the upper and lower direction “Z”. The second plate part 62 is provided with frame side fixed parts 64 fixed to the housing 12 in its four corners. The frame side fixed part 64 is provided with a fixed hole 66 through which a bolt 65 for fixing the frame 28 to the housing 12 can be penetrated. Further, the second plate part 62 is respectively provided with a positioning hole 67 between the two fixed holes 66 located on one side in the width direction “Y” and between the two fixed holes 66 located on the other side in the width direction “Y”. The positioning hole 67 on the one side in the width direction “Y” is an elongated hole which is extended in the width direction “Y”, and the other positioning hole 67 in the width direction “Y” is a circular hole. The frame 28 is positioned to the fixing part 12a by inserting positioning protruded parts not shown protruded from the fixing part 12a of the housing 12 into the positioning holes 67. Further, the frame 28 is fixed to the fixing part 12a of the housing 12 by the bolts 65 penetrated through the fixed holes 66.

The third plate part 63 is extended to the upper side “Z2” perpendicular to the second plate part 62 from an end edge of the second plate part 62 on the opposite side to the first plate part 61. The first plate part 61 and the third plate part 63 are parallel to each other.

As shown in FIG. 4, the motor 20 is fixed to the first plate part 61 in a state that the rotation shaft 25 is penetrated through the through hole 60 and the end face 36a (output side end plate member 36) of the motor case 26 is contacted with the first plate part 61. The motor case 26 is located on an opposite side (second direction “X2”) of the first plate part 61 to the third plate part 63. In this embodiment, the motor case 26 is fixed to the first plate part 61 by welding. A tip end of the rotation shaft 25 of the motor 20 is supported by a support part 68 provided in the third plate part 63. The support part 68 is provided with a recessed part which is recessed to the first direction “X1” and the tip end of the rotation shaft 25 is inserted into the recessed part. In this embodiment, the rotation shaft 25 is urged to the support part 68 by the urging member 40 fixed to the motor case 26. The support part 68 rotatably supports the rotation shaft 25.

A male screw part 70 is provided in an output side portion 25a of the rotation shaft 25 which is protruded to the first direction “X1” from the motor case 26. The male screw part 70 is located between the first plate part 61 and the third plate part 63. A movable member 80 is movably attached to the male screw part 70.

In this embodiment, as shown in FIG. 3, when a state that the motor 20 is fixed to the first plate part 61 is viewed in the axial line direction “X”, the first plate part 61 is provided with a first protruded portion 71 and a second protruded portion 72 which are protruded to an outer side in the radial direction with respect to the motor case 26. The second protruded portion 72 is protruded in an opposite direction to the first protruded portion 71 with the through hole 60 interposed therebetween. In this embodiment, the first protruded portion 71 is protruded to one side in the width direction “Y” with respect to the motor case 26, and the second protruded portion 72 is protruded to the other side in the width direction “Y” with respect to the motor case 26. As shown in FIG. 6, the first protruded portion 71 is provided with a first weight fixing hole 73 for fixing a vibration suppressing member 29. The second protruded portion 72 is provided with a second weight fixing hole 74 for fixing a vibration suppressing member 29.

In this embodiment, the vibration suppressing member 29 is a weight made of metal. The drive device 10 includes a first weight 75 and a second weight 76 as the weight. The first weight 75 is fixed to the first protruded portion 71 by utilizing the first weight fixing hole 73. The second weight 76 is fixed to the second protruded portion 72 by utilizing the second weight fixing hole 74. The first weight 75 and the second weight 76 are the same member and have the same weight. The first weight 75 and the second weight 76 are made of metal having a specific gravity larger than those of the motor case 26 and the frame 28. The first weight 75 and the second weight 76 are, for example, made of brass.

Each of the first weight 75 and the second weight 76 is provided with a weight main body part 77 which is contacted with a face on the second direction “X2” side of the first plate part 61 to cover the weight fixing hole (first weight fixing hole 73 or second weight fixed hole 74), and a shaft part 78 which is protruded to the first direction “X1” from the weight main body part 77 to penetrate through the weight fixing hole (first weight fixing hole 73 or second weight fixed hole 74). The shaft part 78 is provided with a plastically deformed portion 79 at an end on the first direction “X1” side on an opposite side to the weight main body part 77 so that the plastically deformed portion 79 is contacted with a face on the first direction “X1” side of the first plate part 61 to cover the weight fixing hole (first weight fixing hole 73 or second weight fixed hole 74). In other words, each of the first weight 75 and the second weight 76 is fixed to the first plate part 61 by penetrating the shaft part 78 through the weight fixing hole (first weight fixing hole 73 or second weight fixed hole 74) from the second direction “X2” side and plastically deforming an end part on the first direction “X1” side of the shaft part 78 by caulking or the like.

The guide shaft 30 is extended between the first plate part 61 and the third plate part 63. In other words, an end portion on the first direction “X1” side of the guide shaft 30 is fixed to the third plate part 63, and an end portion on the second direction “X2” side of the guide shaft 30 is fixed to the first plate part 61.

### (Movable Member and Switch)

As shown in FIG. 4, the movable member 80 is disposed between the first plate part 61 and the third plate part 63. The movable member 80 includes a first nut 83 and a second nut 84 which are meshed with the male screw part 70 of the rotation shaft 25 and a movable member main body 85 which supports the first nut 83 and the second nut 84 in a non-rotatable manner. The first nut 83 is disposed on the first direction “X1” side with respect to the second nut 84. As shown in FIG. 5, the movable member main body 85 is provided with a base part 87 having a guide hole 86 through which the guide shaft 30 is penetrated, a connection part 88 with which the tip end portion 11a of the link member 11 extended from the mirror holder 15 is connected, and a nut support part 89 which supports the first nut 83 and the second nut 84.

The base part 87 is made of resin and is formed in a rectangular solid shape. As shown in FIG. 2, the guide hole 86 is penetrated through a center in the width direction “Y” of the base part 87 in the axial line direction “X”. The connection part 88 is provided on the upper side “Z2” of the base part 87. The nut support part 89 is provided on the lower side “Z1” of the base part 87. The movable member main body 85 is restricted from turning around the axial line “L” by penetrating the guide shaft 30 through the guide hole 86.

The connection part 88 includes a resilient connection part 91 provided in an end portion on the first direction “X1” side of the base part 87 and a fixed connection part 92 which faces the resilient connection part 91 with a space interposed therebetween on the second direction “X2” side with respect to the resilient connection part 91. The resilient connection part 91 includes a first wall part 93 extended to the upper side “Z2” from the base part 87 and a plate spring 94 fixed to the first wall part 93.

The first wall part 93 is made of resin and is integrally provided with the base part 87. The plate spring 94 is provided with a first plate spring portion 94a extended in the upper and lower direction “Z”, a second plate spring portion 94b which is bent to the second direction “X2” from an upper end of the first plate spring portion 94a and is extended to the lower side “Z1”, and a third plate spring portion 94c which is bent to the first direction “X1” from a lower end of the second plate spring portion 94b and is extended to the lower side “Z1”. A bent part 94d protruding to the second direction “X2” is provided between the second plate spring portion 94b and the third plate spring portion 94c. The first plate spring portion 94a is fixed to the first wall part 93, and its upper end portion is protruded from the first wall part 93 to the upper side “Z2”. The second plate spring portion 94b is inclined from the upper side “Z2” with respect to the first wall part 93 toward the second direction “X2” and to the lower side “Z1”. The bent part 94d is located on the second direction “X2” side with respect to the first wall part 93.

The fixed connection part 92 is made of a member made of metal such as stainless steel. The fixed connection part 92 is integrally formed with the movable member main body 85 by insert molding. In other words, a lower end portion of the fixed connection part 92 is embedded in the movable member main body 85. The fixed connection part 92 is provided with a protruded part 92a protruding to the first direction “X1”. The protruded part 92a faces the bent part 94d of the resilient connection part 91 with a space interposed therebetween in the axial line direction “X”.

In this embodiment, the tip end portion 11a of the link member 11 extended from the mirror holder 15 is inserted between the bent part 94d of the plate spring 94 of the resilient connection part 91 and the protruded part 92a of the fixed connection part 92. In a state that the tip end portion 11a of the link member 11 is inserted between the bent part 94d and the protruded part 92a, the plate spring 94 is elastically deformed to urge the tip end portion 11a to the protruded part 92a. Therefore, even in a case that a vehicle on which the head-up display device 1 is mounted is vibrated, the tip end portion 11a of the link member 11 is prevented from disengaging from between the bent part 94d and the protruded part 92a.

The nut support part 89 is provided with a vertical plate part 95 extended to the lower side “Z1” from the base part 87 and a lateral plate part 96 extended to the other side in the width direction “Y” from a lower end of the vertical plate part 95. The vertical plate part 95 is extended from an end in the first direction “X1” of the base part 87 to its end in the second direction “X2” in a state that a height dimension in the upper and lower direction “Z” of the vertical plate part 95 is constant. The lateral plate part 96 faces the base part 87 with a constant space interposed therebetween. Further, the nut support part 89 is provided with a protruded part 96a which is protruded to the upper side “Z2” from an end in the second direction “X2” of the lateral plate part 96. The protruded part 96a is extended in the width direction “Y” along an end edge in the second direction “X2” of the lateral plate part 96. In addition, the nut support part 89 is provided with a rib 96b extended in the width direction “Y” on an upper face of the lateral plate part 96. The rib 96b is provided on the first direction “X1” side with respect to the protruded part 96a and is extended in parallel to the protruded part 96a. Further, the nut support part 89 is provided with a first rib 87a provided on an under face of the base part 87 at a position facing the rib 96b and a second rib 87b provided at a position facing the protruded part 96a. The first rib 87a and the second rib 87b of the base part 87 are extended in parallel to each other in the width direction “Y”.

The first nut 83 is provided with a first rectangular tube part 83a whose outer shape is rectangular and a first cylindrical tube part 83b which is extended to the second direction “X2” from the first rectangular tube part 83a. Inner circumferential faces of the first rectangular tube part 83a and the first cylindrical tube part 83b are provided with a female screw which is threadedly engaged with the male screw part 70. The first nut 83 is disposed in an end portion on the first direction “X1” side of the nut support part 89 in a state that the female screw is threadedly engaged with the male screw part 70 of the rotation shaft 25. In a state that the first nut 83 is disposed in the nut support part 89, the movable member 80 (under face of the base part 87 and the lateral plate part 96) is abutted with an outer peripheral face of the first rectangular tube part 83a, and thereby turning of the first nut 83 with respect to the movable member 80 is restricted.

The second nut 84 is provided with a second rectangular tube part 84a whose outer shape is rectangular and a second cylindrical tube part 84b which is extended to the first direction “X1” from the second rectangular tube part 84a. Inner circumferential faces of the second rectangular tube part 84a and the second cylindrical tube part 84b are provided with a female screw which is threadedly engaged with the male screw part 70. The second nut 84 is disposed on the second direction “X2” side of the nut support part 89 in a state that the female screw is threadedly engaged with the male screw part 70 of the rotation shaft 25. The first nut 83 and the second nut 84 are disposed so that the first cylindrical tube part 83b and the second cylindrical tube part 84b are faced each other. The first nut 83 and the second nut 84 are separated from each other in the axial line direction “X”.

The second rectangular tube part 84a of the second nut 84 is disposed between the rib 96b of the lateral plate part 96 and the protruded part 96a. Therefore, the second rectangular tube part 84a of the second nut 84 is disposed between the first rib 87a and the second rib 87b of the base part 87. The rib 96b of the lateral plate part 96 and the first rib 87a of the base part 87 are capable of abutting with the second rectangular tube part 84a from the first direction “X1” side. The protruded part 96a of the lateral plate part 96 and the second rib 87b are capable of abutting with the second rectangular tube part 84a from the second direction “X2” side. In a state that the second nut 84 is disposed in the nut support part 89, the movable member 80 (under face of the base part 87 and the lateral plate part 96) is abutted with an outer peripheral face of the second rectangular tube part 84a, and thereby turning of the second nut 84 with respect to the movable member 80 is restricted. The second cylindrical tube part 84b is extended to the first direction “X1” between the rib 96b and the first rib 87a in the upper and lower direction “Z” and is protruded to the first direction “X1” with respect to the rib 96b and the first rib 87a.

In this embodiment, a coiled spring 99 is disposed between the movable member main body 85 and the first nut 83. The coiled spring 99 surrounds the rotation shaft 25, the first cylindrical tube part 83b of the first nut 83, and the second cylindrical tube part 84b of the second nut 84. An end on the first direction “X1” side of the coiled spring 99 is abutted with the first rectangular tube part 83a of the first nut 83. An end on the second direction “X2” side of the coiled spring 99 is abutted with the rib 96b of the lateral plate part 96 and the first rib 87a of the base part 87. The coiled spring 99 is compressed between the movable member main body 85 and the first nut 83 to exert an urging force which urges the movable member main body 85 to the second direction “X2”. As a result, the movable member main body 85 is set in a state that the rib 96b of the lateral plate part 96 and the first rib 87a of the base part 87 are always abutted with the second rectangular tube part 84a of the second nut 84 from the first direction “X1” side.

When the rotation shaft 25 is rotated to one side direction by driving of the motor 20, the first nut 83 and the second nut 84 whose turnings around the axial line “L” are restricted by the movable member main body 85 are moved to the first direction “X1”. In this case, the movable member main body 85 is abutted with the second nut 84 from the first direction “X1” side. Therefore, the movable member 80 is moved to the first direction “X1” with movement of the second nut 84 to the first direction “X1”. On the other hand, when the rotation shaft 25 is rotated to the other side direction by driving of the motor 20, the first nut 83 and the second nut 84 whose turnings around the axial line “L” are restricted by the movable member main body 85 are moved to the second direction “X2”. In this case, when the first nut 83 is moved to the second direction “X2”, the movement of the first nut 83 to the second direction “X2” is transmitted to the movable member main body 85 through the coiled spring 99. In other words, when the first nut 83 is moved to the second direction “X2”, the movable member main body 85 is pushed to the second direction “X2” by the first nut 83. As a result, the movable member main body 85 is moved to the second direction “X2” in a state that the movable member main body 85 is pushed to the second nut 84.

The coiled spring 99 always urges the second nut 84 to the second direction “X2” through the movable member main body 85. Therefore, a backlash between the female screw of the second nut 84 and the male screw part 70 is reduced. Further, the coiled spring 99 always urges the first nut 83 to the first direction “X1” by a reaction force for urging the movable member main body 85 to the second direction “X2”. Therefore, a backlash between the female screw of the first nut 83 and the male screw part 70 is reduced. Accordingly, occurrence of rattling is restrained when the movable member 80 is moved in the axial line direction “X” by rotation of the rotation shaft 25.

The switch 81 is a pushing type switch 81 having a pressed part 81a. As shown in FIG. 4, the switch 81 is supported by the first plate part 61 in a state that the pressed part 81a is protruded from the first plate part 61 to the first direction “X1”. In this embodiment, a concave face on the second direction “X2” side of the protruded part 92a of the fixed connection part 92 of the movable member 80 is provided at a position facing the pressed part 81a in the axial line direction “X”. Therefore, when the movable member 80 is moved to the second direction “X2” to reach a predetermined reference position, the pressed part 81a is pressed by the movable member 80 (fixed connection part 92). Therefore, the control part 23 of the head-up display device 1 is capable of determining whether the movable member 80 is located at the reference position or not based on a signal from the switch 81.

### (Operation of Head-Up Display Device)

In a state that the head-up display device 1 is not operated, the reflecting mirror 7 is located at an initial position. In the drive device 10, the movable member 80 is located at the reference position where the pressed part 81a of the switch 81 is pressed by the movable member 80 (fixed connection part 92). In this state, when the head-up display device 1 is activated, the control part 23 drives the motor 20 to operate the drive device 10. Further, the control part 23 drives the display light emitting device 3 to emit a display light 2.

When the motor 20 is driven, the rotation shaft 25 is rotated to one side direction. Therefore, the movable member 80 is moved to the first direction “X1” along the rotation shaft 25. When the movable member 80 is moved, the link member 11 connected with the movable member 80 is driven. When the link member 11 is driven, the reflecting mirror 7 is turned around the turning center line “L0”. After that, when the motor 20 is driven by a predetermined number of steps, the reflecting mirror 7 is located at a predetermined angular position around the turning center axial line “L”. As a result, the display light 2 to be projected on a windshield is projected at a projection position so as to fit a height of eyes of an occupant.

When an operation of the head-up display device 1 is to be stopped, the control part 23 drives the motor 20 of the drive device 10 to rotate the rotation shaft 25 to the other side direction. As a result, the movable member 80 is moved to the second direction “X2”. After that, when a signal indicating that the pressed part 81a has been pressed is outputted from the switch 81, the control part 23 stops driving of the motor 20. As a result, the movable member 80 is located at the reference position. Further, the reflecting mirror 7 connected with the movable member 80 through the link member 11 is returned to the initial position. The control part 23 stops driving of the display light emitting device 3 in parallel with the operation for returning the movable member 80 to the reference position.

When the motor 20 of the drive device 10 is driven for moving the reflecting mirror 7 from the initial position to a predetermined angular position, noise may occur due to resonance of the stator 32 caused by rotation of the rotor 31. Further, when the motor 20 of the drive device 10 is driven for returning the reflecting mirror 7 to the initial position from the predetermined angular position, noise may occur due to resonance of the stator 32 caused by rotation of the rotor 31.

In order to prevent the problem, in this embodiment, a vibration suppressing member 29 (first weight 75 and second weight 76) is fixed to the first plate part 61 of the frame 28 to which the end face 36a of the motor case 26 is fixed. As a result, a resonance frequency of the motor 20 can be shifted and thus, occurrence of noise from the drive device 10 can be prevented or suppressed. Therefore, occurrence of noise in the head-up display device 1 can be restrained.

Further, in this embodiment, the first weight 75 and the second weight 76 are fixed to the first plate part 61 of the frame 28 and thus, the resonance frequency of the motor 20 can be shifted without performing work on the motor 20 for fixing the first weight 75 and the second weight 76.

In addition, the first plate part 61 is provided with the first protruded portion 71 and the second protruded portion 72 which are protruded to an outer side in the radial direction with respect to the motor case 26 when viewed in the axial line direction “X” along the rotation shaft 25, and the first weight 75 and the second weight 76 which are the vibration suppressing member 29 are respectively fixed to the first protruded portion 71 and the second protruded portion 72. As a result, fixed positions of the first weight 75 and the second weight 76 can be separated from the rotation shaft 25 (rotor 31). Therefore, in comparison with a case that the first weight 75 and the second weight 76 are fixed at positions near to the rotation shaft 25, the resonance frequency of the motor 20 can be shifted by using a weight having light weight.

Further, in this embodiment, the first protruded portion 71 and the second protruded portion 72 are protruded to opposite directions to each other with the rotation shaft 25 of the motor 20, which is fixed to the first plate part 61, interposed therebetween. Therefore, the first weight 75 and the second weight 76 can be disposed on both sides with respect to the rotation shaft 25. As a result, when the rotation shaft 25 is rotated, imbalance of moment occurred in the motor 20 can be restrained. Therefore, vibration of the motor 20 at the time of rotation of the rotation shaft 25 can be restrained.

Further, in this embodiment, the first protruded portion 71 is provided with a first weight fixing hole 73 for fixing the first weight 75. The first weight 75 is fixed to the first plate part 61 by plastically deforming the shaft part 78 penetrating through the first weight fixing hole 73 by caulking or the like. Similarly, the second protruded portion 72 is provided with a second weight fixing hole 74 for fixing the second weight 76. The second weight 76 is fixed to the first plate part 61 by plastically deforming the shaft part 78 by caulking or the like. Therefore, even when a vehicle vibrates and the housing 12 of the head-up display device 1 is vibrated, the first weight 75 and the second weight 76 are prevented or restrained from falling off the frame 28.

In addition, in the first weight 75 and the second weight 76, one side face of the first plate part 61 with which the weight main body part 77 is contacted is the face with which the end face 36a of the motor case 26 is contacted. Therefore, the weight main body part 77 can avoid locating on an outer side in the radial direction of the output side portion 25a of the rotation shaft 25 which is protruded from the motor case 26.

Further, in the drive device 10, the first plate part 61 and the third plate part 63 are connected with each other by the guide shaft 30 and thus, rigidity of the frame 28 is high. Therefore, the frame 28 can be restrained from vibrating when the rotation shaft 25 is rotated.

In accordance with an embodiment of the present invention, the vibration suppressing member 29 may be fixed to the frame 28 by using an adhesive.

### First Modified Embodiment

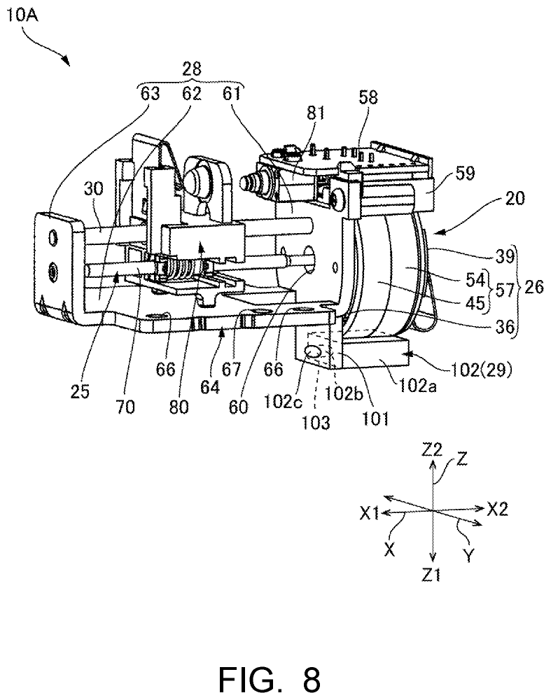

FIG. 8 is a perspective view showing a drive device in a first modified embodiment. A drive device 10A in a first modified embodiment includes structures corresponding to the above-mentioned drive device 10 and thus, corresponding structures are indicated with the same reference signs and their descriptions are omitted. In the drive device 10A in this embodiment, the first plate part 61 of the frame 28 is provided with one protruded portion 101 protruded to the lower side “Z1” in the vertical direction as a protruded portion which is protruded to an outer side in the radial direction with respect to the motor case 26. More specifically, in the frame 28, a portion of the second plate part 62 continuous to the first plate part 61 is cut and bent down to the lower side “Z1”, and the cut-and-bent-down portion is formed to be a protruded portion 101 which is protruded to the lower side “Z1” with respect to the motor case 26.

Further, the drive device 10A includes one weight 102 as the vibration suppressing member 29. The protruded portion 101 is provided with a weight fixing hole 103 for fixing a weight 102. The weight 102 is provided with a weight main body part 102a, a shaft part 102b and a plastically deformed portion 102c, and the weight 102 is fixed to the protruded portion 101 in a state that the shaft part 102b is penetrated through the weight fixing hole 103.

Also in the drive device 10A, the vibration suppressing member 29 is fixed to the first plate part 61 of the frame 28 to which the end face 36a of the motor case 26 is fixed. As a result, a resonance frequency of the motor 20 can be shifted and thus, occurrence of noise can be prevented or restrained. Further, the weight 102 is disposed in a vertical direction with respect to the motor case 26 and thus, imbalance of moment occurred in the motor 20 when the rotation shaft 25 is rotated can be restrained. Therefore, vibration of the motor 20 at the time of rotation of the rotation shaft 25 can be restrained.

### Second Modified Embodiment

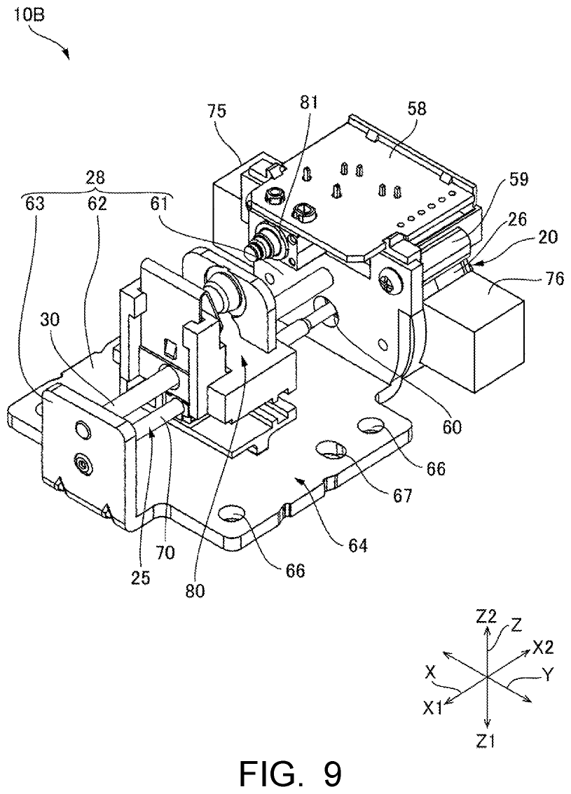

FIG. 9 is a perspective view showing a drive device in a second modified embodiment. A drive device 10B in a second modified embodiment includes structures corresponding to the above-mentioned drive device 10 and thus, corresponding structures are indicated with the same reference signs and their descriptions are omitted. In this embodiment, the drive device 10B includes a first weight 75 and a second weight 76 which are made of metal as the vibration suppressing member 29. The first weight 75 and the second weight 76 are fixed to an outer peripheral face of the motor case 26 with an adhesive. The first weight 75 and the second weight 76 have the same weight as each other and are attached at angle intervals of 180° with the rotation shaft 25 as a center. In the drive device 10B, the first plate part 61 of the frame 28 is provided with no protruded portion which is protruded to an outer side in a radial direction with respect to the motor case 26.

In the drive device 10B in this embodiment, a resonance frequency of the motor 20 is shifted by providing the vibration suppressing member 29 on the motor case 26. As a result, occurrence of noise from the drive device 10B can be prevented or restrained. Further, the first weight 75 and the second weight 76 are disposed on both sides of the rotation shaft 25 and thus, imbalance of moment occurred in the motor 20 when the rotation shaft 25 is rotated can be restrained. Therefore, vibration of the motor 20 at the time of rotation of the rotation shaft 25 can be restrained.

### Third Modified Embodiment

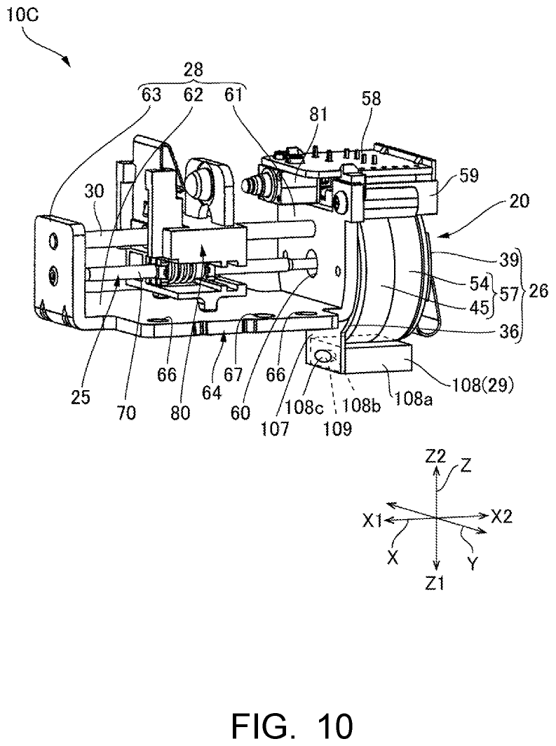

FIG. 10 is a perspective view showing a drive device in a third modified embodiment. A drive device 10C in a third modified embodiment includes structures corresponding to the above-mentioned drive device 10 and thus, corresponding structures are indicated with the same reference signs and their descriptions are omitted. In the drive device 10C in this embodiment, the output side end plate member 36 of the motor case 26 is provided with a case protruded portion 107 which is protruded from the case body 57 (first outer stator core 45 and second outer stator core 54) to an outer side in a radial direction when viewed in the axial line direction “X”. The case protruded portion 107 is protruded from the case body 57 to the lower side “Z1” in the vertical direction.

Further, the drive device 10C includes one weight 108 as the vibration suppressing member 29. The case protruded portion 107 is provided with a weight fixing hole 109 for fixing the weight 108. The weight 108 is provided with a weight main body part 108a, a shaft part 108b and a plastically deformed portion 108c, and the weight 108 is fixed to the case protruded portion 107 in a state that the shaft part 108b is penetrated through the weight fixing hole 109.

Also in the drive device 10C in this embodiment, a resonance frequency of the motor 20 is shifted by providing the vibration suppressing member 29 in the motor case 26. As a result, occurrence of noise from the drive device 10C can be prevented or restrained. Further, the weight 108 is disposed in the motor case 26 in the vertical direction and thus, imbalance of moment occurred in the motor 20 when the rotation shaft 25 is rotated can be restrained. Therefore, vibration of the motor 20 at the time of rotation of the rotation shaft 25 can be restrained.

### Other Embodiments

The vibration suppressing member 29 may be fixed to the third plate part 63 which supports the rotation shaft 25 of the motor 20. Also in this case, a resonance frequency of the motor 20 can be shifted and thus, occurrence of noise is prevented or restrained.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A drive device used in a head-up display device, the drive device being accommodated in a housing of the head-up display device and being fixed to the housing, the drive device comprising:
a motor comprising a rotation shaft and a motor case having an end face through which the rotation shaft is protruded;
a vibration suppressing member; and
a frame comprising a first plate part having a through hole and a second plate part which is extended from the first plate part in a direction intersecting the first plate part;
wherein the motor is fixed to the first plate part in a state that the rotation shaft is penetrated through the through hole and the end face is contacted with the first plate part;
wherein the vibration suppressing member is fixed to the first plate part or the motor case; and
wherein the second plate part comprises a frame side fixed part which is to be fixed to the housing.

2. The drive device according to claim 1, wherein
the first plate part comprises a protruded portion which is protruded to an outer side in a radial direction with respect to the motor case when viewed in an axial line direction along the rotation shaft,
the vibration suppressing member is a weight made of metal, and
the weight is fixed to the protruded portion.

3. The drive device according to claim 2, wherein
the protruded portion comprises a fixing hole for fixing the weight,
the weight comprises a weight main body part which is contacted with one side face of the first plate part to cover the fixing hole, and a shaft part which is protruded from the weight main body part to penetrate through the fixing hole, and
the shaft part comprises a plastically deformed portion which is provided at an end on an opposite side to the weight main body part and is contacted with an other face of the first plate part to cover the fixing hole.

4. The drive device according to claim 3, wherein the one side face of the first plate part with which the weight main body part is contacted is a face with which the end face of the motor case is contacted.

5. The drive device according to claim 2, wherein the protruded portion is protruded in a vertical direction with respect to the motor case.

6. The drive device according to claim 2, wherein
the protruded portion comprises a first protruded portion and a second protruded portion which is protruded to an opposite direction to the first protruded portion with the through hole interposed therebetween, and
the weight comprises a first weight fixed to the first protruded portion and a second weight fixed to the second protruded portion.

7. The drive device according to claim 1, wherein the motor is a stepping motor and is micro step-driven.

8. A head-up display device for a vehicle comprising:
the drive device defined in claim 1;
a reflecting mirror which reflects a display light;
a support mechanism which turnably supports the reflecting mirror around a predetermined turning center line;
a link member which connects the reflecting mirror with a movable member; and
a housing which accommodates the drive device, the support mechanism and the link member;
wherein the frame side fixed part is fixed to the housing; and
wherein when the movable member is moved by driving of the motor, the reflecting mirror is turned around the turning center line.

9. A drive device used in a head-up display device, the drive device being accommodated in a housing of the head-up display device and being fixed to the housing, the drive device comprising:
a motor comprising a rotation shaft and a motor case having an end face through which the rotation shaft is protruded;
a vibration suppressing member; and
a frame comprising a first plate part having a through hole, a second plate part extended from the first plate part in a direction intersecting the first plate part, and a third plate part which faces the first plate part with a space interposed therebetween,
wherein the motor is fixed to the first plate part in a state that the rotation shaft is penetrated through the through hole and the end face is contacted with the first plate part;
wherein a tip end of the rotation shaft penetrated through the through hole is rotatably supported by a support part provided in the third plate part;
wherein the vibration suppressing member is fixed to the first plate part, the third plate part or the motor case, and
wherein the second plate part comprises a frame side fixed part which is to be fixed to the housing.

10. The drive device according to claim 9, wherein
the first plate part comprises a protruded portion which is protruded to an outer side in a radial direction with respect to the motor case when viewed in an axial line direction along the rotation shaft,
the vibration suppressing member is a weight made of metal, and
the weight is fixed to the protruded portion.

11. The drive device according to claim 10, wherein
the protruded portion comprises a fixing hole for fixing the weight,
the weight comprises a weight main body part which is contacted with one side face of the first plate part to cover the fixing hole, and a shaft part which is protruded from the weight main body part to penetrate through the fixing hole, and
the shaft part comprises a plastically deformed portion which is provided at an end on an opposite side to the weight main body part and is contacted with another face of the first plate part to cover the fixing hole.

12. The drive device according to claim 11, wherein the one side face of the first plate part with which the weight main body part is contacted is a face with which the end face of the motor case is contacted.

13. The drive device according to claim 10, wherein the protruded portion is protruded in a vertical direction with respect to the motor case.

14. The drive device according to claim 10, wherein
the protruded portion comprises a first protruded portion and a second protruded portion which is protruded to an opposite direction to the first protruded portion with the through hole interposed therebetween, and
the weight comprises a first weight fixed to the first protruded portion and a second weight fixed to the second protruded portion.

15. The drive device according to claim 9, wherein
the motor comprises a magnet fixed to the rotation shaft and a coil surrounding the magnet from an outer peripheral side,
the motor case comprises a plate member having the end face and a case body in a ring shape which accommodates the magnet and the coil on an inner peripheral side,
the plate member comprises a case protruded portion which is protruded to an outer side in a radial direction from the case body when viewed in an axial line direction along the rotation shaft,
the vibration suppressing member is a weight made of metal, and
the weight is fixed to the case protruded portion.

16. The drive device according to claim 9, wherein the motor is a stepping motor and is micro step-driven.

17. The drive device according to claim 9, further comprising:
a male screw part which is provided in an output side portion of the rotation shaft which is protruded from the motor case;
a guide shaft which is extended between the first plate part and the third plate part so as to be parallel to the rotation shaft; and
a movable member comprising a nut engaged with the male screw part and a guide hole through which the guide shaft is penetrated, the movable member being disposed between the first plate part and the third plate part,
wherein when the rotation shaft is rotated by driving of the motor, the movable member is moved along the rotation shaft.

18. A head-up display device for a vehicle comprising:
the drive device defined in claim 17;
a reflecting mirror which reflects a display light;
a support mechanism which turnably supports the reflecting mirror around a predetermined turning center line;
a link member which connects the reflecting mirror with the movable member; and
a housing which accommodates the drive device, the support mechanism and the link member;
wherein the frame side fixed part is fixed to the housing; and
wherein when the movable member is moved by driving of the motor, the reflecting mirror is turned around the turning center line.
